(19) United States
(12) Patent Application Publication
(10) Pub. No.: US 2026/0141689 A1
(43) Pub. Date: May 21, 2026

(54) RARE OBJECT DETECTION SYSTEM AND METHOD FOR IMAGE CORPUS BUILDING

(71) Applicant: GM GLOBAL TECHNOLOGY OPERATIONS LLC, Detroit, MI (US)

(72) Inventors: Michael Baltaxe, Kfar Saba (IL); Ron Hecht, Raanana (IL); Andrea Forgacs Braunshtain, Netanya (IL); Gershon Celniker, Netanya (IL); Boris Indelman, Herzliya (IL); Carmel Rabinovitz, Haifa (IL)

(73) Assignee: GM GLOBAL TECHNOLOGY OPERATIONS LLC, Detroit, MI (US)

(21) Appl. No.: 18/954,611

(22) Filed: Nov. 21, 2024

(51) Int. Cl. G06V 10/774; B60W 60/00; G06T 7/50; G06V 10/75; G06V 10/82

(52) U.S. Cl. CPC G06V 10/774; B60W 60/001; G06T 7/50; G06V 10/758; G06V 10/82

(57) ABSTRACT

A method for training a neural network including receiving a plurality of images of a driver's field of view, generating a depth information, a driver's gaze probability and a known object indication for each of the plurality of images, estimating a probability of an unknown object within each of the plurality of images in response to the depth information, the driver's gaze probability and the known object indication, generating a plurality of annotated images in response to annotating each of the plurality of images having the probability of the unknown object exceeding a threshold probability to identify the unknown object, wherein each of the plurality of annotated images is annotated to identify the unknown object, and training the neural network in response to the plurality of annotated images.

### INTRODUCTION

The present disclosure generally relates to vehicles, systems and methods for object detection in image processing systems. In particular, an automated method is disclosed for creating curated datasets to enhance the performance of object detection models for identifying rare, proximate, and tall objects within image datasets by combining relative depth estimation, eye gaze prediction, and frequent object detection techniques to identify regions of interest in an image.

Autonomous and semi-autonomous vehicles are capable of sensing their environment and navigating based on the sensed environment. Such vehicles sense their environment using sensing devices such as radar, lidar, image sensors, and the like. The vehicle system further uses information from global positioning systems technology, navigation systems, vehicle-to-vehicle communication, vehicle-to-infrastructure technology, and/or drive-by-wire systems to navigate the vehicle. Vehicle automation has been categorized into numerical levels ranging from Zero, corresponding to no automation with full human control, to Five, corresponding to full automation with no human control. Various automated driver-assistance systems, such as cruise control, adaptive cruise control, and parking assistance systems correspond to lower automation levels, while true “driverless” vehicles correspond to higher automation levels.

To perform the automated driver assistance algorithms, sensor data from vehicle sensors, such as cameras, lidars, radars and the like, are used to detect static and dynamic objects proximate to the vehicle. Object detection using image data captured from vehicle cameras plays a crucial role in enabling autonomous vehicles to perceive their surroundings and make informed decisions. By accurately identifying and localizing objects such as cars, pedestrians, traffic signs, and road markings within camera images, self-driving cars can navigate safely and efficiently. These systems leverage sophisticated algorithms, often powered by deep learning models, to process and interpret visual data in real-time. By understanding the context of their environment, autonomous vehicles can react appropriately to dynamic situations.

Object detection systems used in modern vehicle control systems are created using an image corpus of carefully selected images that serve as the foundation for training and evaluating computer vision models. Creating an image corpus involves image collection, a preprocessing of images and then image annotation by labeling objections, creation of bounding boxes and semantic segmentation. Accordingly, it is desirable to provide systems and method for detecting uncommon or rare objects and for building an image corpus for object detection. Furthermore, other desirable features and characteristics of the present invention will become apparent from the subsequent detailed description and the appended claims, taken in conjunction with the accompanying drawings and the foregoing technical field and background.

### SUMMARY

Disclosed herein are vehicle control methods and systems and related systems for object detection, methods for making and methods for operating such systems, and motor vehicles and other equipment such as aircraft, trucks, buses, forklifts, construction vehicles and other electric vehicles equipped with auxiliary power outlets. By way of example, and not limitation, there are presented various embodiments of systems for creating curated datasets to enhance the performance of object detection models for identifying rare, proximate, and tall objects within image datasets by combining relative depth estimation, eye gaze prediction, and frequent object detection techniques to identify regions of interest in an image

In accordance with an aspect of the present disclosure, a method of building an image corpus for training a neural network including receiving, via an image interface, an image, generating a depth information in response to the image, estimating an object closeness and an object vertical position in response to the depth information, estimating a driver gaze probability in response to the image, detecting a probability of a known object within the image in response to the image, calculating a joint probability of an occurrence of an unknown object within the image in response to the depth information, the object closeness and the object vertical position, the driver gaze probability and the probability of the known object within the image, identifying the image for annotation to generate an annotated image indicative of the unknown object in response to the joint probability exceeding a threshold value, adding the annotated image to the image corpus, and training the neural network in response to the image corpus.

In accordance with another aspect of the present disclosure, wherein the probability of the known object is detected in response to a long-class tail probability.

In accordance with another aspect of the present disclosure, controlling a vehicle along a motion path in response to a subsequent unknown object identified by the neural network in a subsequent image.

In accordance with another aspect of the present disclosure, wherein the neural network is a convolutional neural network.

In accordance with another aspect of the present disclosure, wherein the image corpus includes a plurality of images having a plurality of joint probabilities of the occurrence of the unknown object exceeding the threshold value.

In accordance with another aspect of the present disclosure, wherein the image includes a plurality of pixels and wherein a calculation of the joint probability generates the probability of the occurrence of the unknown object for each of the plurality of pixels.

In accordance with another aspect of the present disclosure, wherein the object vertical position is indicative of an object height.

In accordance with another aspect of the present disclosure, wherein a joint probability calculation is higher for an image pixel in response to the driver gaze probability for the image pixel overlapping a low depth area of the image.

In accordance with another aspect of the present disclosure, wherein the image corpus is formed from a plurality of annotated images indicative of the unknown object in response to the joint probability exceeding the threshold value for each of the plurality of annotated images.

In accordance with another aspect of the present disclosure, a system for building an image corpus for training a neural network including an input for receiving an image, an image processor for generating a depth information in response to the image, for estimating an object closeness and an object vertical position in response to the depth information, for estimating a driver gaze probability in response to the image, detecting a probability of a known object within the image in response to the image, calculating a joint probability of an occurrence of an unknown object within the image in response to the depth information, the object closeness and the object vertical position, the driver gaze probability and the probability of the known object within the image, identifying the image for annotation to generate an annotated image indicative of the unknown object in response to the joint probability exceeding a threshold value, and a neural network processor for receiving the annotated image, for adding the annotated image to the image corpus, and training the neural network in response to the image corpus.

In accordance with another aspect of the present disclosure, wherein the image processor is further operative to calculate a long-class tail probability in response to a detection of the known object within the image and wherein the joint probability is calculated in response to the long-class tail probability.

In accordance with another aspect of the present disclosure, wherein the image corpus includes a plurality of images having a plurality of joint probabilities of the occurrence of the unknown object exceeding the threshold value.

In accordance with another aspect of the present disclosure, wherein a joint probability calculation is higher for an image pixel in response to the driver gaze probability for the image pixel overlapping a low depth area of the image.

In accordance with another aspect of the present disclosure, wherein the image corpus is formed from a plurality of annotated images indicative of the unknown object in response to the joint probability exceeding the threshold value for each of the plurality of annotated images.

In accordance with another aspect of the present disclosure, wherein the object vertical position is indicative of an object height.

In accordance with another aspect of the present disclosure, wherein the image includes a plurality of pixels and wherein a joint probability calculation generates the probability of the occurrence of the unknown object for each of the plurality of pixels.

In accordance with another aspect of the present disclosure, wherein the image corpus is formed from a plurality of annotated images indicative of the unknown object in response to the joint probability exceeding the threshold value for each of the plurality of annotated images.

In accordance with another aspect of the present disclosure further including a vehicle controller for controlling a vehicle along a motion path in response to a subsequent unknown object identified by the neural network in a subsequent image.

In accordance with another aspect of the present disclosure, a method for training a neural network including receiving a plurality of images of a driver's field of view wherein each of the plurality of images includes a plurality of pixels, generating a depth information, a driver's gaze probability and a known object indication for each of the plurality of images, wherein the known object indication is determined in response to a long-class tail probability, estimating a probability of an unknown object within each of the plurality of images in response to the depth information, the driver's gaze probability and the known object indication wherein estimating the probability of the unknown object includes calculating a joint probability in response to the probability of the unknown object for each of the plurality of pixels and wherein the joint probability is higher in response to the driver gaze probability for the image pixel overlapping a low depth area of the image, generating a plurality of annotated images in response to annotating each of the plurality of images having the probability of the unknown object exceeding a threshold probability to identify the unknown object, wherein each of the plurality of annotated images is annotated to identify the unknown object, and training the neural network in response to the plurality of annotated images.

In accordance with another aspect of the present disclosure, controlling a vehicle along a motion path in response to a subsequent unknown object identified by the neural network in a subsequent image.

### BRIEF DESCRIPTION OF THE DRAWINGS

The exemplary embodiments will hereinafter be described in conjunction with the following drawing figures, wherein like numerals denote like elements, and wherein:

FIG. 1 is a functional block diagram illustrating an autonomous or semi-autonomous vehicle system utilizing an object detection system, in accordance with various embodiments;

FIG. 2 shows an object detection system for rare object detection and image corpus building, in accordance with various embodiments;

FIG. 3 shows exemplary images indicative of the rare object detection system and method for image corpus building, in accordance with various embodiments; and

FIG. 4 shows a flow chart indicative of a method or rare object detection system and method for image corpus building, in accordance with various embodiments.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. As used herein, the term module refers to any hardware, software, firmware, electronic control component, processing logic, and/or processor device, individually or in any combination, including without limitation: application specific integrated circuit, an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of systems, and that the systems described herein is merely exemplary embodiments of the present disclosure.

For the sake of brevity, conventional techniques related to signal processing, data transmission, signaling, control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

Systems and methods described herein provide a robust object detection system by creating a corpus of images for use by training object detectors that focuses on close, tall and rare objects, in a long-tailed distribution, such as objects that are less frequently observed. In the automotive domain, common objects such as vehicles, pedestrians, and road signs are routinely encountered. The disclosed method uses relative depth, eye gaze estimation and frequent object detection to find images with high, close and rare objects, without using specific queries or rare object detectors to find such frames. In particular, the systems and methods are proposed using a two-stage approach to detect and classify rare, proximate, and tall objects within an image. The initial stage employs a combination of gaze estimation and depth estimation techniques to identify potential regions of interest. This stage prioritizes geometric and salient cues, rather than semantic object recognition. Subsequently, a frequent object detector is applied to these regions. By comparing the detected objects against a database of common objects, the system can effectively isolate rare instances that may signify unusual or hazardous scenarios. This approach enables the detection of anomalous objects that may pose potential risks to autonomous vehicle systems.

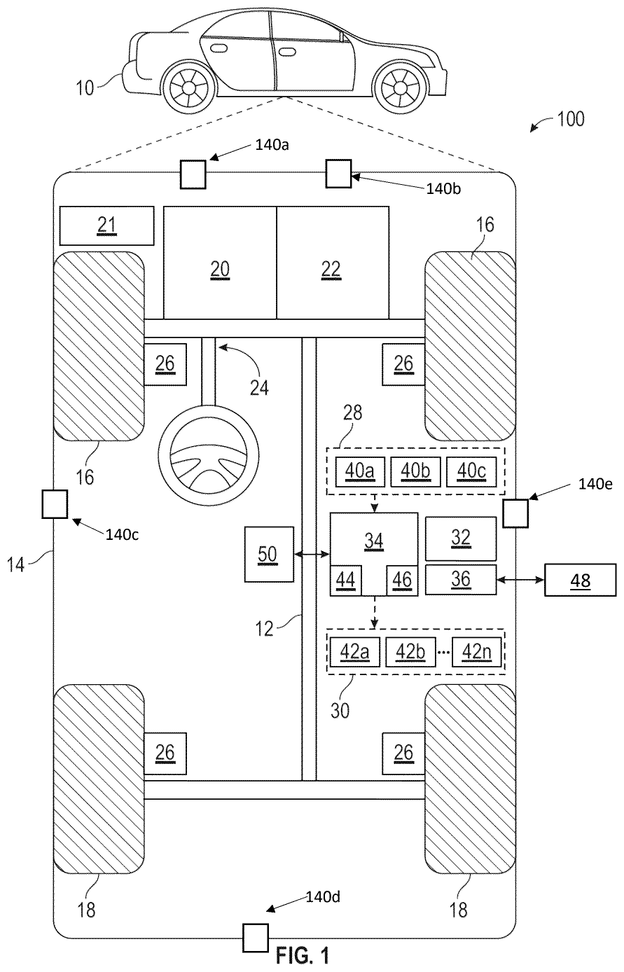

With reference to FIG. 1, a vehicle system shown generally at 100 is associated with a vehicle 10 in accordance with various embodiments. In general, the vehicle system 100 includes an object detection system 200 that is configured to detect locations of static, dynamic, common and uncommon proximate objects. The vehicle 10 generally includes a chassis 12, a body 14, front wheels 16, and rear wheels 18. The body 14 is arranged on the chassis 12 and substantially encloses components of the vehicle 10. The body 14 and the chassis 12 may jointly form a frame. The wheels 16-18 are each rotationally coupled to the chassis 12 near a respective corner of the body 14.

In some embodiments, the vehicle 10 is an autonomous vehicle and the static object detection system 200 is incorporated into the autonomous vehicle 10 (hereinafter referred to as the autonomous vehicle 10). The present description concentrates on an exemplary application in autonomous vehicle applications. It should be understood, however, that the static object detection system 200 described herein is envisaged to be used in semi-autonomous automotive vehicles.

The autonomous vehicle 10 is, for example, a vehicle that is automatically controlled to carry passengers from one location to another. The vehicle 10 is depicted in the illustrated embodiment as a passenger car, but it should be appreciated that any other vehicle including motorcycles, trucks, sport utility vehicles, recreational vehicles, marine vessels, aircraft, etc., can also be used. In an exemplary embodiment, the autonomous vehicle 10 is a so-called Level Four or Level Five automation system. A Level Four system indicates “high automation”, referring to the driving mode-specific performance by an automated driving system of all aspects of the dynamic driving task, even if a human driver does not respond appropriately to a request to intervene. A Level Five system indicates “full automation”, referring to the full-time performance by an automated driving system of all aspects of the dynamic driving task under all roadway and environmental conditions that can be managed by a human driver.

As shown, the autonomous vehicle 10 generally includes a propulsion system 20, a transmission system 22, a steering system 24, a brake system 26, a sensor system 28, an actuator system 30, at least one data storage device 32, at least one controller 34, and a communication system 36. The propulsion system 20 may, in various embodiments, include an internal combustion engine, an electric machine such as a traction motor, and/or a fuel cell propulsion system. The transmission system 22 is configured to transmit power from the propulsion system 20 to the vehicle wheels 16-18 according to selectable speed ratios. According to various embodiments, the transmission system 22 may include a step-ratio automatic transmission, a continuously-variable transmission, or other appropriate transmission. The brake system 26 is configured to provide braking torque to the vehicle wheels 16-18. The brake system 26 may, in various embodiments, include friction brakes, brake by wire, a regenerative braking system such as an electric machine, and/or other appropriate braking systems. The steering system 24 influences a position of the vehicle wheels 16-18. While depicted as including a steering wheel for illustrative purposes, in some embodiments contemplated within the scope of the present disclosure, the steering system 24 may not include a steering wheel.

The sensor system 28 includes one or more sensing devices 40a-40n that sense observable conditions of the exterior environment and/or the interior environment of the autonomous vehicle 10. The sensing devices 40a-40n can include, but are not limited to, radars, lidars, global positioning systems, optical cameras 140a-140n, thermal cameras, ultrasonic sensors, and/or other sensors. The optical cameras 140a-140n are mounted on the vehicle 10 and are arranged for capturing images (e.g. a sequence of images in the form of a video) of an environment surrounding the vehicle 10. In the illustrated embodiment, there are two front cameras 140a, 140b arranged for respectively imaging a wide angle, near field of view and a narrow angle, far field of view. Further illustrated are left-side and right-side cameras 140c, 140e and a rear camera 140d. The number and position of the various cameras 140a-140n is merely exemplary and other arrangements are contemplated.

The sensor system 28 includes one or more of the following sensors for use in detecting locations of static, dynamic, common and uncommon proximate objects. The sensor system 28 may include a steering angle sensor, a wheel speed sensor, an inertial measurement unit, a global positioning system, an engine sensor, and a throttle and/or brake sensor. The sensor system 28 provides a measurement of translational speed and angular velocity in the input vector 204.

The actuator system 30 includes one or more actuator devices 42a-42n that control one or more vehicle features such as, but not limited to, the propulsion system 20, the transmission system 22, the steering system 24, and the brake system 26. In various embodiments, the vehicle features can further include interior and/or exterior vehicle features such as, but are not limited to, doors, a trunk, and cabin features such as air, music, lighting, etc. (not numbered).

The data storage device 32 stores data for use in automatically controlling the autonomous vehicle 10. In various embodiments, the data storage device 32 stores defined maps of the navigable environment. As can be appreciated, the data storage device 32 may be part of the controller 34, separate from the controller 34, or part of the controller 34 and part of a separate system.

The controller 34 includes at least one processor 44 and a computer readable storage device or media 46. The processor 44 can be any custom made or commercially available processor, a central processing unit, a graphics processing unit, an auxiliary processor among several processors associated with the controller 34, a semiconductor based microprocessor (in the form of a microchip or chip set), a macroprocessor, any combination thereof, or generally any device for executing instructions. The computer readable storage device or media 46 may include volatile and nonvolatile storage in read-only memory, random-access memory, and keep-alive memory, for example. Keep-alive memory is a persistent or non-volatile memory that may be used to store various operating variables while the processor 44 is powered down. The computer-readable storage device or media 46 may be implemented using any of a number of known memory devices such as programmable read-only memory, electrically programmable read-only memory, electrically erasable programmable read-only memory, flash memory, or any other electric, magnetic, optical, or combination memory devices capable of storing data, some of which represent executable instructions, used by the controller 34 in controlling the autonomous vehicle 10.

The instructions may include one or more separate programs, each of which comprises an ordered listing of executable instructions for implementing logical functions. The instructions, when executed by the processor 44, receive and process signals from the sensor system 28, perform logic, calculations, methods and/or algorithms for automatically controlling the components of the autonomous vehicle 10, and generate control signals to the actuator system 30 to automatically control the components of the autonomous vehicle 10 based on the logic, calculations, methods, and/or algorithms. Although only one controller 34 is shown in FIG. 1, embodiments of the autonomous vehicle 10 can include any number of controllers 34 that communicate over any suitable communication medium or a combination of communication mediums and that cooperate to process the sensor signals, perform logic, calculations, methods, and/or algorithms, and generate control signals to automatically control features of the autonomous vehicle 10.

In various embodiments, one or more instructions of the controller 34 are embodied in the object detection system 200 and, when executed by the processor 44, are configured to implement the methods and systems described herein for detecting locations of static, dynamic, common and uncommon proximate objects.

The communication system 36 is configured to wirelessly communicate information to and from other entities 48, such as but not limited to, other vehicles, infrastructure, remote systems, and/or personal devices. In an exemplary embodiment, the communication system 36 is a wireless communication system configured to communicate via a wireless local area network or by using cellular data communication. However, additional or alternate communication methods, such as a dedicated short-range communications channel, are also considered within the scope of the present disclosure. Dedicated short-range communications channel refer to one-way or two-way short-range to medium-range wireless communication channels specifically designed for automotive use and a corresponding set of protocols and standards.

As can be appreciated, the subject matter disclosed herein provides certain enhanced features and functionality to what may be considered as a standard or baseline autonomous vehicle 10. To this end, an autonomous vehicle can be modified, enhanced, or otherwise supplemented to provide the additional features described in more detail below. The subject matter described herein concerning the static object detection system 200 is not just applicable to autonomous driving applications, but also other driving systems having one or more automated features utilizing automatic traffic object detection, particularly the location of static traffic objects to control an automated feature of the vehicle 10.

In accordance with an exemplary autonomous driving application, the controller 34 implements an autonomous driving system 70. That is, suitable software and/or hardware components of the controller 34, for example, the processor 44 and the computer-readable storage device 46, are utilized to provide an autonomous driving system 70 that is used in conjunction with vehicle 10.

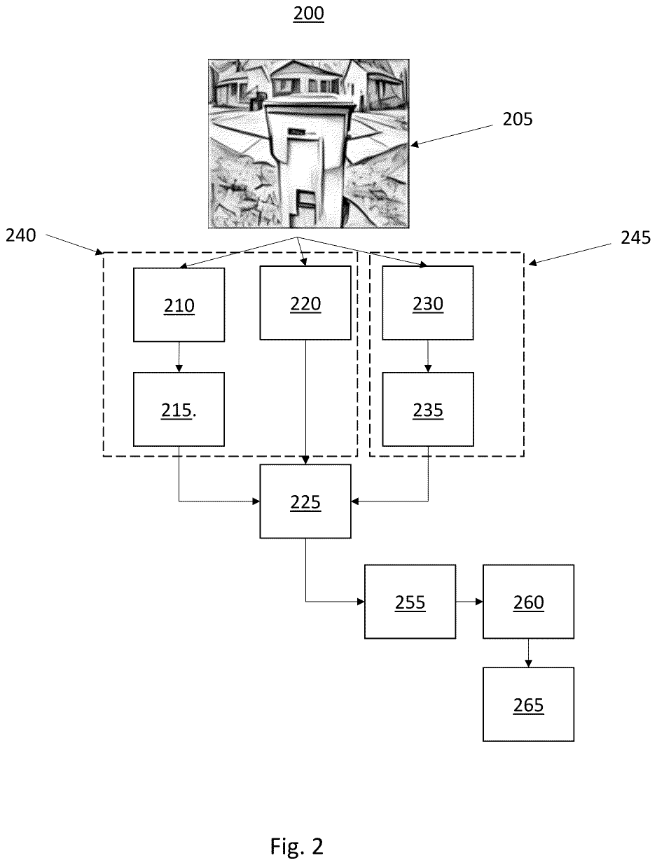

In various embodiments, the instructions of the autonomous driving system 70 may be organized by function, module, or system. For example, as shown in FIG. 2, the autonomous driving system 70 can include a computer vision system 74, a positioning system 76, a guidance system 78, and a vehicle control system 80. As can be appreciated, in various embodiments, the instructions may be organized into any number of systems (e.g., combined, further partitioned, etc.) as the disclosure is not limited to the present examples.

In various embodiments, the computer vision system 74 synthesizes and processes sensor data and predicts the presence, location, classification, and/or path of objects and features of the environment of the vehicle 10. In various embodiments, the computer vision system 74 can incorporate information from multiple sensors, including but not limited to cameras, lidars, radars, and/or any number of other types of sensors. The computer vision system 74 includes an object detection module and the object detection system 200.

The positioning system 76 processes sensor data along with other data to determine a position (e.g., a local position relative to a map, an exact position relative to lane of a road, vehicle heading, velocity, etc.) of the vehicle 10 relative to the environment. The guidance system 78 processes sensor data along with other data to determine a path for the vehicle 10 to follow. The vehicle control system 80 generates control signals for controlling the vehicle 10 according to the determined path. The positioning system 76 may process a variety of types of localization data in determining a location of the vehicle 10 including Inertial measurement unit data, global positioning system data, real-time kinematic correction data, cellular and other wireless data, etc.

In various embodiments, the controller 34 implements machine learning techniques to assist the functionality of the controller 34, such as feature detection/classification, obstruction mitigation, route traversal, mapping, sensor integration, ground-truth determination, and the like. One such machine learning technique performs traffic object detection whereby traffic objects are identified, localized and optionally the status is determined for further processing by the guidance system 78. The machine learning technique may be implemented by a convolutional neural network. For example, a traffic control device such as a traffic light, may be identified and localized and the light status determined. The feature detection and classification in two-dimensions may be performed by the object detection. Depending on the state of the traffic light (e.g. red for stop or green for go), the guidance system 78 and the vehicle control system 80 operate together to determine whether to stop or go at the traffic lights. The three-dimensional location of the traffic control device and other static traffic objects support localization of the vehicle 10 by the positioning system 76 such as lane alignment of the vehicle 10 and the traffic control device.

As mentioned briefly above, the static object detection system can be included within the autonomous driving system 70 in autonomous driving applications, for example in operable communication with the computer vision system 74, the positioning system 76, the guidance system 78 and the vehicle control system 80. The static object detection system 200 is configured to detect locations of static, dynamic, common and uncommon proximate objects and the vehicle control system 80 is responsive thereto to generate an automated control command. The vehicle control system 80 works with the actuator system 30 to traverse such a trajectory.

Referring to FIG. 2, an object detection system 200 for rare object detection and image corpus building is further illustrated in accordance with exemplary embodiments. The object detection system 200 is configured to generate a substantial dataset of meticulously labeled images including the identification and labeling of rare or uncommon objects. In the automotive environment, common objects can include vehicles, pedestrians, and road signs, among others. However, rare objects present a significant challenge in this regard, as they occur infrequently within standard datasets. Consequently, manually identifying and annotating instances of rare objects is a time-consuming and laborious task. To streamline this process, an automated approach is disclosed for discovering frames containing rare objects. By leveraging techniques such as relative depth estimation 210, eye gaze prediction 220, and known object detection 230, the object detection system 200 identifies regions of interest without relying on explicit object queries or specialized rare object detectors.

The exemplary method performed by the object detection system 200 is configured into two modules. The first module 240 detects whether close, tall objects exist in an image, and the second one verifies that those objects are not common. The first module 240 may not include object semantics, and estimates geometric and salient properties. The first module 240 employs two components used for uncommon object detection. The first is gaze estimation 220, which predicts where a person might fixate in a given input image. The second uses depth estimation 210 to estimate the existence of close and high objects in the image. The second module 245 is a frequent object detector. By joining the two modules, an estimation can be made as to whether there is a close, high and rare object in the image.

Depth estimation 210, such as monocular depth estimation, can be performed to infer depth information in a scene from an image 205 captured by a vehicle camera. Techniques such as feature extraction performed by a deep neural network, such as a convolutional neural network, processes the image to extract relevant features, such as edges, textures, and object shapes to estimate depth. These extracted features can then be input into a network that predicts the depth for each pixel in the image. This can be done by regressing a depth value for each pixel, or by classifying pixels into different depth bins. Finally, additional techniques like refinement networks or post-processing steps can be applied to improve the accuracy of the depth predictions.

The object detection system 200 next determines a close and high probability 215 of the detected objects. In some exemplary embodiments, flat terrain is assumed to allow the object detection system 200 to relate the Y coordinate of the image to the object's height relative to the camera. A depth estimation map can then be used to provide relative depth values for each pixel in the image. The largest value in the depth estimation map can correspond to the closest point to the camera. Close objects will have a large disparity value. Disparity is the difference in the horizontal position of a point in the left and right images of a stereo pair. Larger disparities indicate closer objects. High objects will have a small Y coordinate. Assuming flat terrain, objects higher in the image are closer to the camera.

The close_object_probability is calculated using close_object_probability=(1−normalized_Y_coord)*normalized_disparity). This calculation provides that the Y coordinate is normalized to a value between 0 and 1. Subtracting this from 1 gives a value that increases as the object is higher in the image (smaller Y coordinate). This term rewards objects that are higher in the image (closer to the camera). The disparity value is also normalized to a value between 0 and 1. This term rewards objects with larger disparities (closer to the camera). Multiplying these two terms together effectively combines both criteria. A high object (small Y coordinate) will have a large (1−normalized_Y_coord) value. A close object (large disparity) will have a large normalized_disparity value. Therefore, the close_object_probability will be high only for objects that are both close and high in the image. This formula provides a way to quantify the likelihood of an object being both close and high based on its position in the image and its disparity value.

The first module 240 is also configured to perform a gaze probability 220 for the image. A neural network can be configured to learn and predict driver gaze direction in order to predict where a driver might fixate in a given input image. In some exemplary embodiments, a convolutional neural network can be to extract relevant features from the input image. An image having a suitable size and format can first be captured of the driver's face as input. The system can then extract features from the image, such as edges, textures, and shapes. These layers are then employed to learn to identify patterns in the image that are indicative of specific gaze directions. Pooling layers can be used to reduce the spatial dimensions of the feature maps, making the network more computationally efficient. They also help to make the network more robust to small variations in the input image. Fully connected layers can be used to flatten the output of the convolutional layers into a one-dimensional vector. These layers learn to map the extracted features to the predicted gaze direction. In response to these inputs, the gaze probability 220 can produce a probability distribution over a set of possible gaze directions. This distribution represents the network's confidence in each possible gaze direction. The gaze probability distribution can then be used to train the network, using a dataset of images paired with corresponding ground truth gaze directions. The network is trained to minimize the difference between its predicted gaze distribution and the ground truth distribution.

The second module 245 includes a known object detector 230 configured to detect known objects within the image 205. In the automotive environment, common objects are vehicles, pedestrians, and road signs (among others). In some exemplary embodiments, neural network AI programs can be used to detect known, common objects in images through a process of deep learning. These networks are trained on extensive datasets of labeled images, learning to recognize patterns and features associated with specific objects. When presented with a new image, the network processes it layer by layer, extracting features such as edges, shapes, and textures. These extracted features are then compared to the learned patterns, and the network assigns probabilities to potential object classifications. The object with the highest probability is identified as the detected object within the image. This enables the network to accurately recognize objects in diverse images, even under varying conditions like lighting changes, partial occlusions, and different viewpoints.

If an object is detected, by the known object detector 230, the second module 245 includes a long-tail class probability model 235 configured to generate a binary image from the image and the object detection results with a 0 representative of known or standard objects and 1 elsewhere. For example, a long-tail class probability model 235, when configured to generate a binary image from an input image and its corresponding object detection results, functions by assigning a probability to each pixel in the image. This probability reflects the likelihood that the pixel belongs to an object class that is not commonly seen or well-represented in the training data, referred to as a “long-tail” class. The model processes the object detection results to identify known or standard objects and assigns a probability of 0 to the pixels corresponding to these objects. Conversely, pixels associated with objects that are less frequent or unfamiliar to the model are assigned a probability of 1. By thresholding these probabilities, the model generates a binary image where 0 represents known objects and 1 indicates potential anomalies or objects of interest. This approach helps to highlight regions in the image that require further investigation or specialized handling.

In response to the close and high probability 215, the gaze probability 220 and the binary image from the long-tail class probability model 235 are then combined to generate a joint probability calculation result 225. The joint probability calculation result 225 is indicative of a probability of a rare object within the image. The joint probability calculation result 225 can be quantized for each pixel in the image using the following formula:

P(rare object)=P(close object)*P(gaze)*(1−P(common object))

The formula calculates the probability of a “rare object” being present in an image. It considers three factors, the probability of a close object which is the likelihood that an object is located close to the observer, the probability of gaze which represents the chance that the observer's attention is directed towards the object, and the probability of a standard object, which is the likelihood the object is a common object, such as a car, pedestrian, bicycle, etc. The formula multiplies the probabilities of a close object and gaze, and then multiplies that product by the probability that the object is not standard. This final product represents the probability of a rare object being present. The summation symbol (Σ) indicates that this calculation is performed for multiple potential pixels in the image.

The object detection system 200 is next configured to sum the probabilities 255 on the entire image according to the following:

Sum=Σ(P(rare object))

The summation for an image is indicative of the probability of an image containing a rare or uncommon object within the gaze of a driver. The object detection system 200 then selects a number of images 260 to be sent for annotation 265.

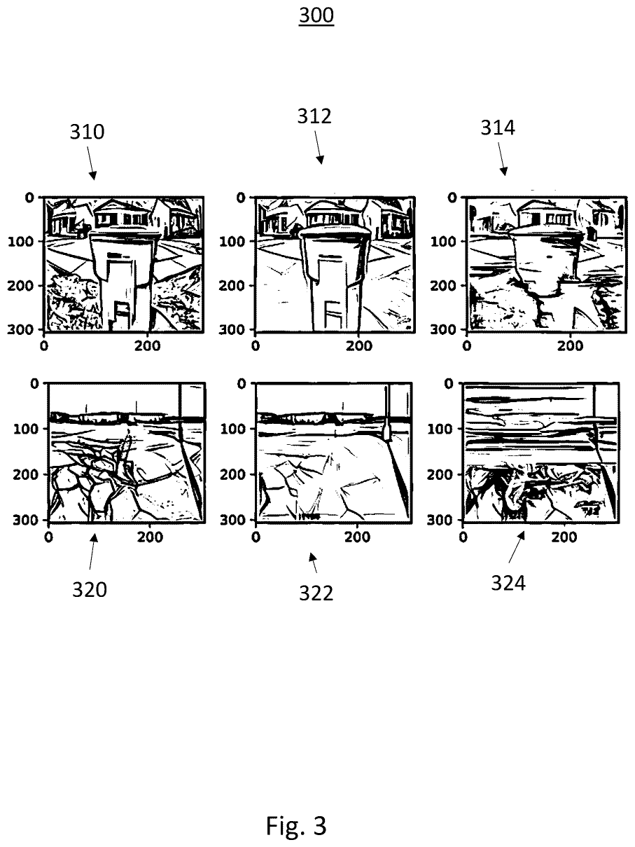

Turning now to FIG. 3, exemplary images 300 are shown indicative of the rare object detection system and method for image corpus building in accordance with exemplary embodiments. The upper images 310, 312, 314 are indicative of images with a close object detected, having a clear close depth, and a high probability of gaze. The lower images 320, 322, 324 are indicative of images with objects detected further away, having a gradual shift of depth and low gaze probability.

The first upper image 310 is indicative of an image captured by a vehicle camera having an object close to the vehicle within the camera field of view. The second upper image 312 is indicative of results from the depth estimation wherein an object is close to the vehicle. The third upper image 314 is indicative of the probability of a driver's gaze being directed in a direction corresponding to a particular pixel within the first upper image 310.

The second lower image 320 is indicative of an image captured by a vehicle camera not having an object close to the vehicle within the camera field of view. The second lower image 312 is indicative of results from the depth estimation of a view not having an object close to the vehicle within the view. The third lower image 314 is indicative of the probability of a driver's gaze being directed in a direction corresponding to a particular pixel within the first upper image 320. The lower images 320, 322, 324 are indicative of objects being further away, having a gradual shift of depth and a low gaze probability where gaze is where a driver is predicted to look at.

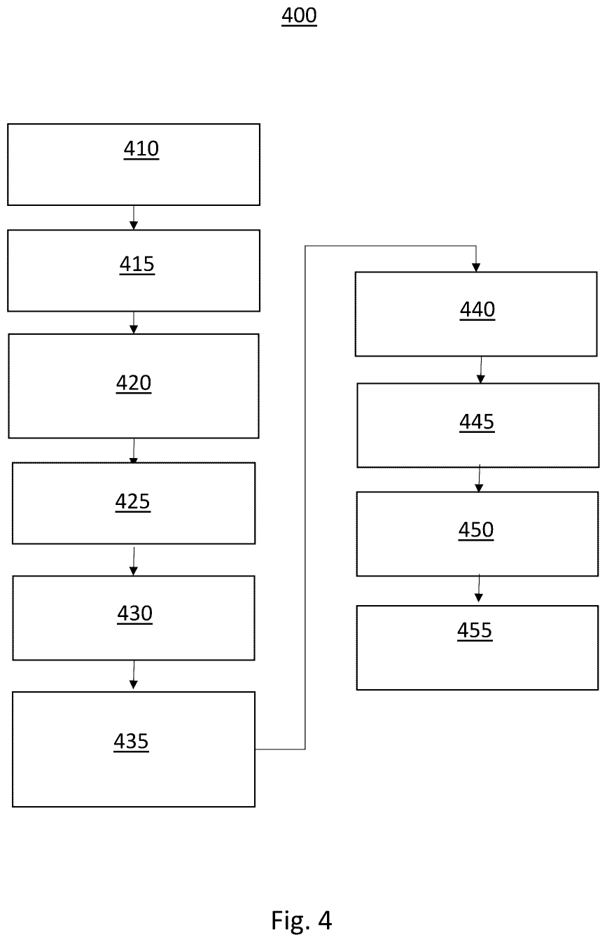

Continuing to refer to FIG. 4, a flow chart indicative of a method 400 for rare object detection system and method for image corpus building in accordance with exemplary embodiments is shown. The method 400 is operative to partially automate the generation an image corpus to be used to train a neural network to detect uncommon or rare objects is systems such as automotive object detection systems and/or automated driver assistance systems.

The method 400 is first operative to receive 410 an image. In some exemplary embodiments, the image can be captured by a vehicle camera or the like and transmitted to the object detection system. The method 400 next determines a depth information 415 for the image. In some exemplary embodiments, a depth information can be determined for each pixel in the image. Alternately, an average depth can be determined for a cluster if pixels, such as four pixels, nine pixels or the like.

The method next determines 420 a closeness of the object and a highness in response to the depth information. The closeness of the object and a highness of the object in the image is indicative of the probability of an object being close to the observer in an image, assuming flat terrain. In some exemplary embodiments, the Y coordinate of the depth information is normalized to represent the vertical position of the object in the image. A smaller Y coordinate indicates a higher position, which is generally associated with closer objects on flat terrain. The method 400 normalizes this value to ensure that a higher position leads to a larger contribution to the closeness probability. The method 400 further normalizes any disparity in the depth data. Disparity is a measure of depth difference between two points. A larger disparity indicates a closer object. The method 400 can normalize disparity to provide a consistent scale for comparison and directly incorporates it into the calculation of the closeness probability. By multiplying these two normalized factors, the method can capture the combined effect of both factors: a higher position and larger disparity increase the probability of an object being close to the observer.

The method 400 next determines a gaze probability 425 for locations within the image. In some exemplary embodiments, determining driver's gaze probability within a field of view captured in the image can involve machine learning algorithms trained on models on large datasets of driving scenarios with labeled gaze data to learn complex patterns and predict gaze probability based on various factors, including scene context, road conditions, and driver behavior. The driver gaze can be determined by leverages knowledge of the driving environment to predict likely gaze targets. For example, a driver is more likely to focus on traffic lights, pedestrians, or other road users than on irrelevant objects in the field of view.

While determining the depth information and gaze probability, the method 400 can further detect 430 if known objects are present in the image. Known objects can include vehicles, pedestrians, road signs, bicycles, and other objects commonly detected in automative vehicle control systems. The method 400 next uses this detected common object information to determine a long-tail class probability 435 for detected objects within the image. A long-tail class probability refers to the probability of an instance belonging to a class that is underrepresented or rare within a dataset. This concept arises in scenarios where the distribution of classes is imbalanced, with a few dominant classes (the “head”) and many less frequent classes (the “tail”). Key characteristics of long-tail class probabilities include low frequency classes where the classes occur infrequently compared to the dominant classes. Long-tail class probabilities imbalances where the dataset is skewed towards the majority classes, making it challenging to train models that accurately predict long-tail classes. Despite their low frequency, long-tail classes can be crucial in certain applications, such as classification of infrequently detected objects in automative computer vision applications. These infrequently detected objects can include unusual road conditions, icy roads, flooded roads, or debris on the road, uncommon vehicles such as vintage cars, motorcycles, or large trucks, unconventional pedestrians, such as people on bicycles, rollerblades, or wearing unusual clothing and rare traffic signs, such as: construction signs, temporary speed limit signs, or less common regulatory signs.

The method 400 is next operative to calculate 440 a joint probability for the image in response to the depth information, closeness and high probability, gaze probability, known object detection and long-tail class probability. The object detection system can generate a joint probability for an image by integrating the various cues, including depth information, object detection results, and gaze probability. In some exemplary embodiments, the system can calculate a joint probability for each pixel in the image, representing the likelihood of it belonging to a specific class or region of interest. This joint probability can be used to prioritize areas for further analysis, such as anomaly detection or decision-making for autonomous driving. The joint probability can use weighted values for each of the variables.

After determining a joint probability for each image in a plurality of images, the method 400 is next operative to sum 445 the probabilities for the entire image. The method next operative to select 450 a number of images having the highest sum to send for annotation. Finally, the method 400 annotates 455 these images to be indicative of the uncommon object detected. These annotated images can be used to build an image corpus to be used to train the object detection neural network.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method of building an image corpus for training a neural network comprising:
receiving, via an image interface, an image;
generating a depth information in response to the image;
estimating an object closeness and an object vertical position in response to the depth information;
estimating a driver gaze probability in response to the image;
detecting a probability of a known object within the image in response to the image;
calculating a joint probability of an occurrence of an unknown object within the image in response to the depth information, the object closeness and the object vertical position, the driver gaze probability and the probability of the known object within the image;
identifying the image for annotation to generate an annotated image indicative of the unknown object in response to the joint probability exceeding a threshold value;
adding the annotated image to the image corpus; and
training the neural network in response to the image corpus.

2. The method of building the image corpus for training the neural network of claim 1, wherein the probability of the known object is detected in response to a long-class tail probability.

3. The method of building the image corpus for training the neural network of claim 1, further comprising controlling a vehicle along a motion path in response to a subsequent unknown object identified by the neural network in a subsequent image.

4. The method of building the image corpus for training the neural network of claim 3, wherein the neural network is a convolutional neural network.

5. The method of claim 1, wherein the image corpus includes a plurality of images having a plurality of joint probabilities of the occurrence of the unknown object exceeding the threshold value.

6. The method of building the image corpus for training the neural network of claim 1, wherein the image includes a plurality of pixels and wherein a calculation of the joint probability generates the probability of the occurrence of the unknown object for each of the plurality of pixels.

7. The method of building the image corpus for training the neural network of claim 1, wherein the object vertical position is indicative of an object height.

8. The method of building the image corpus for training the neural network of claim 1, wherein a joint probability calculation is higher for an image pixel in response to the driver gaze probability for the image pixel overlapping a low depth area of the image.

9. The method of building the image corpus for training the neural network of claim 1, wherein the image corpus is formed from a plurality of annotated images indicative of the unknown object in response to the joint probability exceeding the threshold value for each of the plurality of annotated images.

10. A system for building an image corpus for training a neural network comprising:
an input for receiving an image;
an image processor for generating a depth information in response to the image, for estimating an object closeness and an object vertical position in response to the depth information, for estimating a driver gaze probability in response to the image, detecting a probability of a known object within the image in response to the image, calculating a joint probability of an occurrence of an unknown object within the image in response to the depth information, the object closeness and the object vertical position, the driver gaze probability and the probability of the known object within the image, identifying the image for annotation to generate an annotated image indicative of the unknown object in response to the joint probability exceeding a threshold value; and
a neural network processor for receiving the annotated image, for adding the annotated image to the image corpus, and training the neural network in response to the image corpus.

11. The system for building the image corpus for training the neural network of claim 10, wherein the image processor is further operative to calculate a long-class tail probability in response to a detection of the known object within the image and wherein the joint probability is calculated in response to the long-class tail probability.

12. The system for building the image corpus for training the neural network of claim 10, wherein the image corpus includes a plurality of images having a plurality of joint probabilities of the occurrence of the unknown object exceeding the threshold value.

13. The system for building the image corpus for training the neural network of claim 10, wherein a joint probability calculation is higher for an image pixel in response to the driver gaze probability for the image pixel overlapping a low depth area of the image.

14. The system for building the image corpus for training the neural network of claim 10, wherein the image corpus is formed from a plurality of annotated images indicative of the unknown object in response to the joint probability exceeding the threshold value for each of the plurality of annotated images.

15. The system for building the image corpus for training the neural network of claim 10, wherein the object vertical position is indicative of an object height.

16. The system for building the image corpus for training the neural network of claim 10, wherein the image includes a plurality of pixels and wherein a joint probability calculation generates the probability of the occurrence of the unknown object for each of the plurality of pixels.

17. The system for building the image corpus for training the neural network of claim 10, wherein the image corpus is formed from a plurality of annotated images indicative of the unknown object in response to the joint probability exceeding the threshold value for each of the plurality of annotated images.

18. The system for building the image corpus for training the neural network of claim 10, further including a vehicle controller for controlling a vehicle along a motion path in response to a subsequent unknown object identified by the neural network in a subsequent image.

19. A method for training a neural network comprising:
receiving a plurality of images of a driver's field of view wherein each of the plurality of images includes a plurality of pixels;
generating a depth information, a driver's gaze probability and a known object indication for each of the plurality of images, wherein the known object indication is determined in response to a long-class tail probability;
estimating a probability of an unknown object within each of the plurality of images in response to the depth information, the driver's gaze probability and the known object indication wherein estimating the probability of the unknown object includes calculating a joint probability in response to the probability of the unknown object for each of the plurality of pixels;
generating a plurality of annotated images in response to annotating each of the plurality of images having the probability of the unknown object exceeding a threshold probability to identify the unknown object, wherein each of the plurality of annotated images is annotated to identify the unknown object; and
training the neural network in response to the plurality of annotated images.

20. The method for training the neural network of claim 19 further including controlling a vehicle along a motion path in response to a subsequent unknown object identified by the neural network in a subsequent image.
